(19) United States
(12) Patent Application Publication
(10) Pub. No.: US 2024/0348153 A1
(43) Pub. Date: Oct. 17, 2024

(54) STATE FEED-BACK CONTROLLER FOR CONTROLLING A POWER CONVERTER

(71) Applicant: Huawei Digital Power Technologies Co., Ltd., Shenzhen (CN)

(72) Inventors: Alvaro MORALES MUNOZ, Nuremberg (DE); Francisco Daniel FREIJEDO FERNÁNDEZ, Nuremberg (DE)

(21) Appl. No.: 18/618,841

(22) Filed: Mar. 27, 2024

Related U.S. Application Data
(63) Continuation of application No. PCT/EP2021/076435, filed on Sep. 27, 2021.

(51) Int. Cl. H02M 1/12; H02M 1/00; H02M 7/537

(52) U.S. Cl. CPC H02M 1/126; H02M 1/0025; H02M 7/537

(57) ABSTRACT

A state feed-back controller including a first gain stage with a first gain parameter, a second gain stage with a second gain parameter, a reference input to receive a reference value; a feed-back loop and a combiner for combining an output value of the first gain stage, an output value of the second gain stage and an output value of the feed-back loop. The state feed-back controller can be operated in a current mode or in a voltage mode.

### CROSS-REFERENCE TO RELATED APPLICATIONS

This application is a continuation of International Application No. PCT/EP2021/076435, filed on Sep. 27, 2021, the disclosure of which is hereby incorporated by reference in its entirety.

### FIELD

The disclosure relates to a state feed-back controller for controlling a power converter and a power converter controlled by the state feed-back controller. The disclosure describes a power converter with LC/LCL output filter controlled for passivity and reduced sensing needs that may be applied as Uninterruptible Power Supply (UPS) or Photovoltaic (PV) inverter.

### BACKGROUND

Uninterruptible Power Supply (UPS) and Photovoltaic (PV) Inverters must be stable and robust in all scenarios. These components cannot have unexpected resonances and the control must be fast and reliable. Such inverters may be implemented as Neutral Point Clamped (NPC) or Active Neutral Point Clamped (ANPC) inverters, for example. Another main characteristic of the converters employed is the use of LC or LCL output filters; this enhances the pulse width modulation (PWM) ripple mitigation performance, but at the cost of a more challenging control design and implementation.

### SUMMARY

An aspect of the present disclosure is to provide a solution for a power converter with corresponding control that is stable, robust and reliable in all scenarios.

The present disclosure introduces a controller implementation for a power converter that reduces the needs for high-bandwidth capacitor voltage sensing.

This solution described in the present disclosure is achieved by the features of the independent claims and further embodiments and/or implementations are included in the dependent claims, the description, and the figures.

The present disclosure introduces a novel and unique controller implementation that achieves passivity in all the spectrum for inverters with an output LC (or LCL and higher order) filter. Furthermore, this controller implementation reduces the needs for high-bandwidth capacitor voltage sensing.

An exemplary embodiment of this disclosure focuses on wide-spectrum passivity compliance to assure stability: the controller actions make the system equivalent output impedance (as seen from the point of connection of the inverter at all frequencies of the spectrum) as a passive element: any resonance/oscillation in the electric circuit (e.g., parallel or series resonances) will be always damped (mitigated) by the inverter. In other words, the inverter will not be a source of instability but a system that mitigates external oscillations when present in its terminals.

When focusing on the high-bandwidth operation as said, inner control actions rely on the inductor current and capacitor voltage sensing. Following state feed-back methods, the large bandwidth control action that sets the output impedance leads to a control action which is a linear combination of both variables. However, in practice, relying on current sensors instead of voltage sensors seems a desirable choice: current sensors provide a naturally filtered curve that avoids noise, aliasing, expensive acquisition systems. In embodiments, the disclosed controller implementation can remove the capacitor voltage variable from the high frequency control actions—as described below. As a reference, it can be assumed that high frequencies are from one tenth of the control sampling frequency.

When dealing with regulation of the main components of currents or/and voltages (first/main harmonic correspond usually to 50/60 Hz), the system shows a fast transient response and zero-steady-state error. This behavior can be extended to low order harmonics, usually 5^{th}, 7^{th}, 11^{th}, 13^{th}, etc. In the case of accurate regulation of the capacitor output voltage, this can be sensed, but performance requirements of this sensor are not as stringent as in the case of full bandwidth control action required.

As mentioned above, this disclosure describes an inverter for PV inverters or UPS applications. The improvements described in the present disclosure may mitigate huge losses of time and effort caused by malfunctions in PV inverters or UPS systems. For example, a PV inverter can destabilize a power system, or a sensitive load can be lost in data centers. In both scenarios the present disclosure provide describes improvements that provide more reliability and cost less to systems associated with PV inverters or UPS systems.

In the present disclosure the following terms, abbreviations, and notations will be used:
UPS Uninterruptible Power Supply
PV Photovoltaic
NPC Neutral Point Clamped
ANPC Active Neutral Point Clamped
LC filter Filter comprising inductor, L and capacitor, C
LCL filter Filter comprising inductor, L, capacitor, C and inductor, L
DC direct current
AC alternating current

Exemplary embodiments of the present disclosure describe electric grids. An electric grid is an interconnected network for delivering or distributing electricity from producers to consumers. It may comprise generating stations that produce electric power, electrical substations for stepping electrical voltage up for transmission or down for distribution, high voltage transmission lines that carry power from distant sources to demand centers, and distribution lines that connect individual customers.

Power converters, also referred to as power electronics converters, as described in the present disclosure are applied for converting electric energy from one form to another, such as converting between DC to AC, AC to DC or DC to DC, e.g. between high or medium voltage DC and low voltage DC. A power converter can also change the voltage or frequency or some combination of these. Power electronics converter are based on power electronics switches that can be actively controlled by applying ON/OFF logic (i.e., PWM operation, usually commanded by a closed loop control algorithm).

Exemplary embodiments of the present disclosure describe a state feed-back controller. A state feed-back controller or state space controller is a controller that performs control over variables called states, e.g., of a power converter, based on state space control techniques. Such a controller or controlling device is any suitable device that can be utilized for controlling physical values such as voltage, current or power and that can be applied for controlling a power converter. A controller or controlling device can be a single micro-controller or processor or a multi-core processor or can include a set of micro-controllers or processors for controlling and/or processing. The controller can perform specific control tasks, for example controlling a converter, according to a software, hardware or firmware application.

According to a first aspect, the present disclosure describes a state feed-back controller (140a, 140b) for controlling a first physical value and a second physical value in a voltage mode or in a current mode, the state feed-back controller comprising: a first gain stage with a first gain parameter, the first gain stage having an input and an output; a second gain stage with a second gain parameter, the second gain stage having an input and an output; a reference input to receive a reference value; a feed-back loop having an input and an output, the input receiving a difference of an input value at the input of the second gain stage and the reference value; a combiner for combining an output value at the output of the first gain stage, an output value at the output of the second gain stage and an output value at the output of the feed-back loop, wherein, when the state feed-back controller is configured to be operative in the current mode, the first physical value is a current value received at the input of the second gain stage, the second physical value is a voltage value received at the input of the first gain stage, and the reference value is a reference current value, and wherein an absolute value of the first gain parameter is smaller than an absolute value of the second gain parameter; or wherein, when the state feed-back controller is configured to be operative in the voltage mode, the first physical value is a current value received at the input of the first gain stage, the second physical value is a voltage value received at the input of the second gain stage, the reference value is a reference voltage value and wherein an absolute value of the second gain parameter is smaller than an absolute value of the first gain parameter.

The first physical value and/or the second physical parameter can be a voltage or a current, for example. It can be a voltage or current in an analog or digital representation, e.g. continuous values or sampled values. The first physical value and/or the second physical parameter can also be any other parameter to be controlled by the state feed-back controller, e.g., a temperature value, a pressure value, a time, a frequency, etc.

The state feed-back controller of the present disclosure provides the advantage of full-spectrum passivity compliance to assure stability. The state feed-back controller actions make the system equivalent output impedance as seen from the point of connection of the power converter at all frequencies of the spectrum as a passive element. Any resonance/oscillation in the electric circuit will be always damped or mitigated by the power converter. That means the power converter will not be a source of instability but a system that mitigates external oscillations when present in its terminals.

In an exemplary embodiment of the state feed-back controller, when the state feed-back controller is configured to be operative in the current mode, the first gain parameter is set to zero or within a range around zero; or, when the state feed-back controller is configured to be operative in the voltage mode, the second gain parameter is set to zero or within a range around zero.

A range around zero means that the first gain parameter and/or the second gain parameter are set to small gain values close to zero, for example in the positive scale values like 0.01, 0.001, 0.0001, 0.00001, etc. or in the negative scale values like −0.01, −0.001, −0.0001, −0.00001, etc.

This provides the advantage that an exact sensing of the first or second gain parameter can be avoided. Thus, the state feed-back controller reduces the need for high-bandwidth capacitor voltage sensing.

In an exemplary embodiment of the state feed-back controller, the state feed-back controller comprises: a second feed-back loop, wherein the second feed-back loop is configured for feeding back an output value of the combiner to the combiner, the second feed-back loop comprising a delay stage for delaying the output value of the combiner and a third gain stage with a third gain parameter for applying the third gain parameter to the delayed output value of the combiner.

In an exemplary embodiment of the state feed-back controller, the feed-back loops are configured according to a design criterion, wherein, when the state feed-back controller is operative in the current mode, the second gain parameter and the third gain parameter are adjusted based on the design criterion of the second feed-back loop; or wherein, when the state feed-back controller is operative in the voltage mode, the first gain parameter and the third gain parameter are adjusted based on the design criterion.

Design criteria for control systems can be one or more of the following: a) transient response (the system's response while it is changing), b) steady-state response (the system's response after it has reached steady-state), c) stability.

In an exemplary embodiment of the state feed-back controller, a system controlled by the state feed-back controller can be modeled resulting in a set of poles grouped in a characteristic equation, wherein the design criterion is based on the characteristic equation of the system controlled by the state feed-back controller, wherein the design criterion is fulfilled adjusting the gain parameters by setting all poles of the characteristic equation in z-domain to a same point in the z-domain.

The main criteria applied are transient response, looking for a high bandwidth, and stability, reaching the passivity. The steady-state behavior design corresponds to the block 322. Therefore, using the characteristic equation of the state-space model of the power converter and the LC filter (after removing the voltage sensor need) (10), it is possible to set the poles of the characteristic equation as far away as possible from the origin (0 Hz). That means all of them must be at the same point i.e., same frequency (using equations 13 and 18, this frequency is obtained). Following this statement, the gains for the state feed-back controller are obtained from (15) and (16). As a concrete example, using the values of table 1, and substituting in the previous equations, the gains are: K=[Kᵢ Kᵥ K_{d}] [4,8133 0 1,0605] and the frequency of the poles is f=8100 Hz.

The system controlled by the state feed-back controller can include a power converter and an LC filter network which can be represented in state-space by the mathematical form:

$$\dot{x} ( t ) = Ax ( t ) + Bu ( t )$$

$$y ( t ) = Cx ( t )$$

as described in more detail below with respect to FIG. 2.

By such modeling, an exact behavior of the system can be predicted and used for stability control.

In an exemplary embodiment of the state feed-back controller, the state feed-back controller comprises: a control output for providing an output value of the combiner as a control signal of the state feed-back controller.

This provides the advantage that the power converter can be exactly controlled by the state feed-back controller via this control signal.

In an exemplary embodiment of the state feed-back controller, when the state feed-back controller is operative in the current mode, the feed-back loop is configured to track the first physical value to the reference value based on a feed-back filter or, when the state feed-back controller is operative in the voltage mode, the feed-back loop is configured to track the second physical value to the reference value based on the feed-back filter.

The feed-back loop performs the tracking of the first physical value by an adjustment of the feed-back filter in order to converge to the reference value. Such a feed-back filter has a transfer function with a number of zeros and a number of poles. An exemplary feed-back filter is shown below with respect to FIG. 2 and equation (19).

Such a feed-back loop provides the advantage that the first and second physical values can be efficiently regulated resulting in a robust and stable performance.

In an exemplary embodiment of the state feed-back controller, the feed-back loop comprises at least one resonant controller in a time-discrete domain, wherein the at least one resonant controller is designed to behave as a passive system within a specified frequency range around a resonant frequency of the at least one resonant controller.

Multiple resonant controllers may be connected in parallel, for example.

Such a resonant controller provides the advantage that the passivity criterion can be fulfilled resulting in a stable performance over all frequencies.

In an exemplary embodiment of the state feed-back controller, the resonant frequency of the at least one resonant controller corresponds to a reference frequency or a harmonic of the reference frequency.

The reference frequency can be any frequency used as a reference. For example a frequency of an oscillator may be used as reference frequency. This provides the advantage of flexible design.

In an exemplary embodiment of the state feed-back controller, the at least one resonant controller is configured to have two poles and can be damped. This means that the passivity criterion can be fulfilled by the resonant controller. The poles are placed in the z-domain in such a manner that a damping is performed by the resonant controller, thereby enabling stable performance.

According to a second aspect, the present disclosure describes a power converter comprising: an input for receiving a direct current, DC, voltage; and at least one output for providing an alternating current, AC, voltage at a reference frequency, wherein the at least one output is connected to an LC filter network, the LC filter network comprising an inductor and a capacitor, wherein the power converter is controlled by a state feed-back controller according to the first aspect. Other output filter structures, such as LCL and higher order configurations that involve a dominant LC behavior in the controller design bandwidth of interest are also included by this definition (e.g., using some materials a capacitor or an inductor may change properties at high frequencies).

Such a power converter controlled by the state feed-back controller provides the advantage of full-spectrum passivity compliance to assure stability. The power converter can be controlled to behave at all frequencies of the spectrum as a passive element. Any resonance/oscillation in the electric circuit will be always damped or mitigated by the power converter. That means that the power converter will not be a source of instability but a system that mitigates external oscillations when present in its terminals.

In an exemplary embodiment of the power converter, the first physical value is a current value at the inductor of the LC filter network and the second physical value is a voltage value at the capacitor of the LC filter network.

This provides the advantage that by determining a current value at the inductor of the LC filter network and a voltage value at the capacitor of the LC filter network, the power converter can be efficiently controlled.

In an exemplary embodiment of the power converter, the power converter is controlled by the state feed-back controller based on a state-space model, the state space model comprising: the current value at the inductor of the LC filter network, the voltage value at the capacitor of the LC filter network, an inductance value of the inductor of the LC filter network, and a capacitance value of the capacitor of the LC filter network.

This provides the advantage that using the state space model enables exact prediction of the behavior of the power converter and thus efficient and stable control.

In an exemplary embodiment of the power converter, the power converter controlled by the state feed-back controller forms with the LC filter network a passive system having an output impedance which phase-angle lies within a predefined range.

This provides the advantage that the passivity criterion can be fulfilled when the predefined range is between −90 degrees and +90 degrees.

In an exemplary embodiment of the power converter, the passive system is configured to damp oscillations generated externally or internally by the power converter and/or the LC filter network.

This provides the advantage that any resonance/oscillation in the electric circuit will be always damped or mitigated by the power converter. That means that the power converter will not be a source of instability but a system that mitigates external oscillations when present in its terminals.

### BRIEF DESCRIPTION OF THE DRAWINGS

Further embodiments of the disclosure will be described with respect to the following figures, in which:

FIG. 1 shows a circuit diagram illustrating an exemplary 3-phase power system 100 with power converter 110 and LC output filter 120;

FIG. 2 shows a block diagram illustrating an exemplary system 200 comprising a power converter 110 with LC output filter 120, a controller 140a, 140b for controlling the power converter 110 and an impedance spectroscopy system;

FIG. 3 shows an example of a circuit diagram illustrating a state feed-back controller 140a according to the disclosure operating in a voltage mode;

FIG. 4 shows an example of a circuit diagram illustrating a state feed-back controller 140b according to the disclosure operating in a current mode;

FIG. 5 shows time diagrams 500a, 500b of the key waveforms for current and voltage produced by the system 200 of FIG. 2;

FIG. 6a shows impedance responses for gain 600a and phase 600b obtained by the system 200 of FIG. 2; and

FIG. 6b shows a zoom representation 600c of the high frequency region of the impedance response for phase 600b shown in FIG. 6a.

### DETAILED DESCRIPTION

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

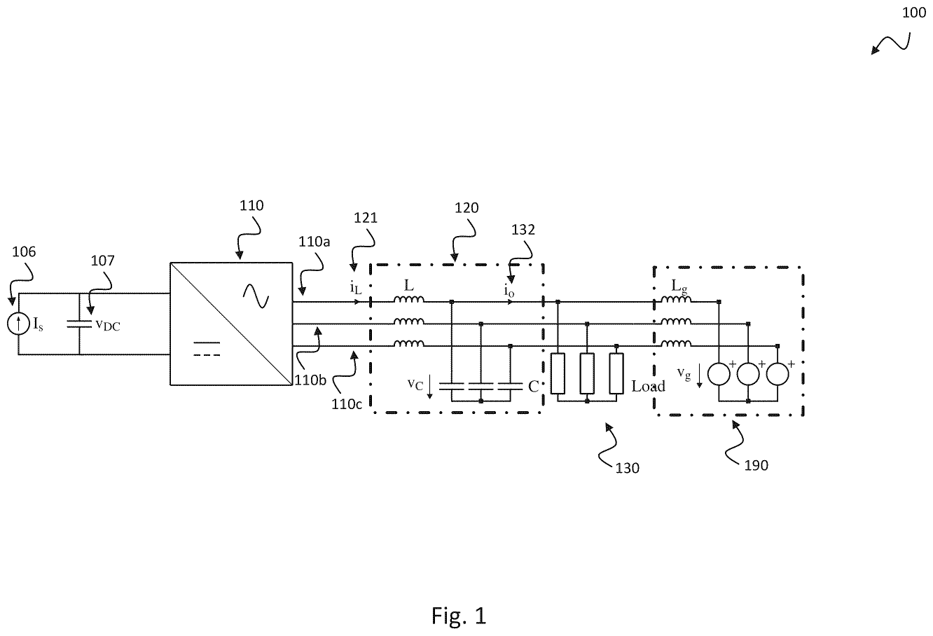

FIG. 1 shows a circuit diagram illustrating an exemplary 3-phase power system 100 with power converter 110, LC output filter 120, load 130 and grid 190. The inductors L_{g} and the voltage sources Vg represent a model of the grid 190. Such a power converter 110 can be controlled by a state feed-back controller as described in this disclosure.

The power system 100 is a three-phase power conversion system 100 for grid connection of a DC power source. The three-phase power conversion system 100 comprises a three-phase power converter 110 having three phase legs 110a, 110b, 110c followed by a three-phase LC filter network 120 with LC filter and load 130 for each phase. A three-phase LCL filter network 120 with LCL filter can be used as well according to embodiments of the current disclosure. Of course, more additional L and/or C layers can be applied for such a filter network 120, e.g., LCLC, LCLCL, etc.

The power converter 110 can be implemented by any power inverter topology. Some examples are Neutral Point Clamped (NPC) or Active Neutral Point Clamped (ANPC), e.g. built with insulated-gate bipolar transistors (IGBTs), or other topologies. An LC or LCL filter 120 follows the power converter 110. The solutions provided by the present disclosure are not dependent on the inverter topology: the unique requirement is the ability to control the output voltage of the inverter (PWM for example). In most applications, the overall regulation strategy (system level) is based on steady-state zero error of input current i_{L} or capacitor voltage v_{C}.

An LCL converter is obtained when adding a second inductor to a LC converter. If the LC inverter or converter achieves a passivity, i.e., it acts like a passive element, the passivity properties of the LC inverters also assures the passivity compliance of the LCL, since the new component added (a single inductor) is by definition also passive. Usually, passivity compliance is a request in the high frequency range, but a whole passivation may be achieved in all range of the spectrum, even when strong control actions are implemented in the low frequency range. For example, a grid frequency of 50 Hz can be considered as a very low frequency when considering a high sampling period, which is the case of the inverters described in the present disclosure and depicted in FIG. 1.

When complying with the passivity criterion, every resonance in the terminals of the inverter is damped by the closed loop operation of the power converter. Usually, the term “active damping” is used in literature to describe the closed loop operation, but passivity compliance is a more general, quantifiable and stringent key performance indicator.

The inverter must follow its references and damp the resonances no matter the external grid conditions. For example, if the grid has voltage harmonics, the system should deal with them, removing them from the current (or regulating them in a precise manner). At this point, it should be clear that the control part is important to achieve the overall performance.

When the power converter 110 is controlled by a state feed-back controller as described in this disclosure, the above requirements can be fulfilled, i.e., passivity criterion is fulfilled and resonances are damped.

The structure of the closed loop control defined in the state-space can be classified in several layers: 1) the most internal loop implements control actions that correspond to a direct state feed-back of system states that determines the stability and passivity compliance in all the controller spectrum; 2) a second layer of control actions are composed from selective harmonic errors and target the regulation of specific components, such as fundamental component of output current or voltage; 3) finally, outer loops, i.e., external loops for power regulation, DC-link regulation, etc., may refer to the ones that calculate references for the so-called second layer.

When controlling the power converter 110 by a state feed-back controller as described in this disclosure, a robust, reliable and fast inner control structure can be achieved. Key to achieving the overall performance is a robust, reliable and fast inner control structure on layers 1 and 2 that can be achieved by state control according to this disclosure, irrespectively from what is implemented in layer 3.

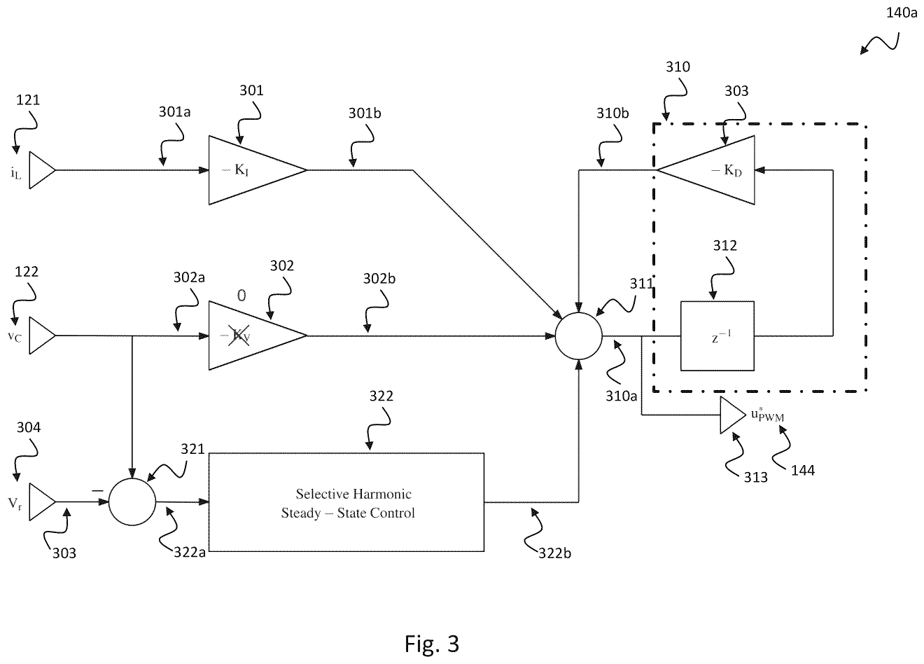

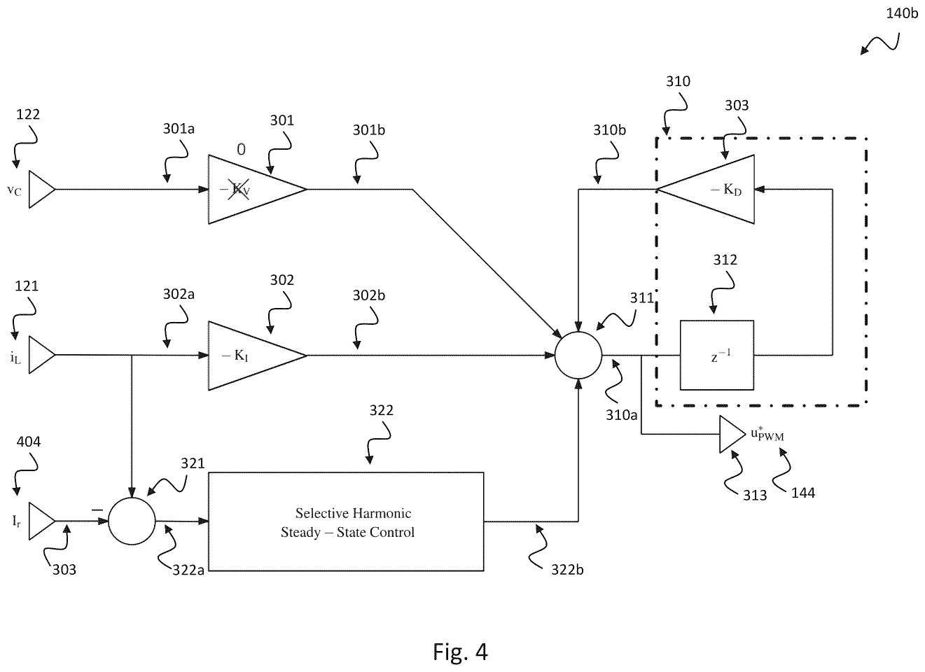

In the present disclosure, layer 3 is no longer considered and not shown in implementations as described below with respect to FIGS. 3 and 4.

As the internal loop actions are the fastest and apply in the whole spectrum, i.e., all the frequencies seen by the inverter, the sensing capabilities used for the variables involved in this loop must have a large bandwidth, i.e., be accurate, noise-less and delay-less in a large range of frequencies. This may imply the need of expensive sensors or acquisition boards. Moreover, the new technology like Gallium nitride (GaN) or Silicon carbide (SiC) transistors will increase the switching frequency, so faster control loop is required to obtain the best performance of these transistors.

When controlling the power converter 110 by a state feed-back controller as described in this disclosure, accurate, noise-less and delay-less sensing capabilities in a large range of frequencies can be achieved. Additionally, increased switching frequencies when implementing GaN or SiC transistors can be applied enabling fast control loop and hence the best performance of these transistors.

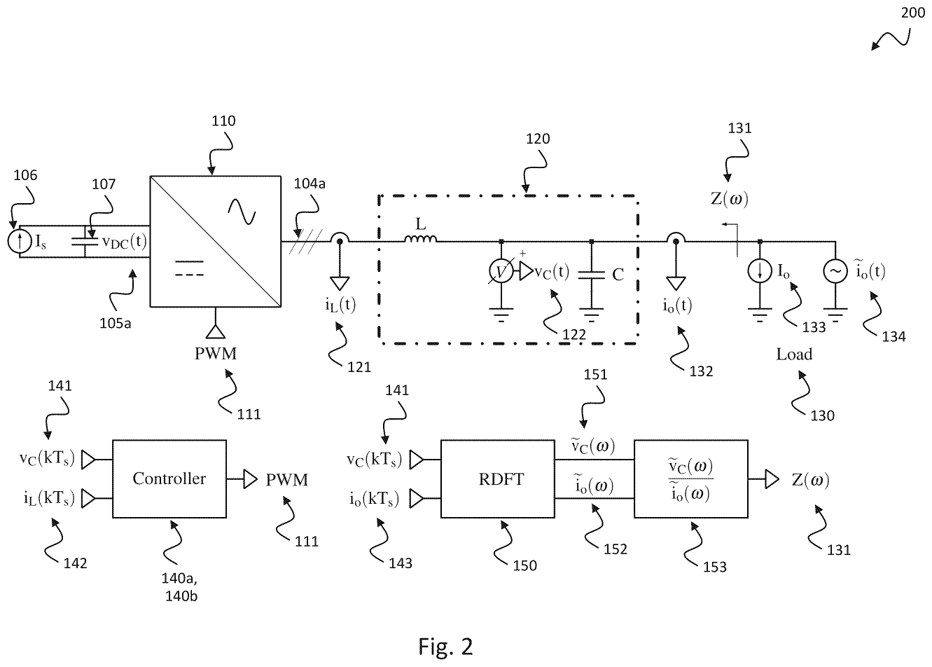

FIG. 2 shows a block diagram illustrating an exemplary system 200 comprising a power converter 110 with LC output filter 120, a controller 140a, 140b for controlling the power converter 110 and an impedance spectroscopy system. The system 200 shows a single phase of the power system 100 described above with respect to FIG. 1.

The power converter 110 comprises an input 105a receiving a DC voltage V_{DC}(t) at a capacitor 107. An input current source 106 provides the input current Is.

The power converter 110 comprises at least one output 104a for providing an alternating current, AC, voltage at a reference frequency. The at least one output 104a is connected to an LC filter network 120 which comprises an inductor L and a capacitor C.

The power converter 110 can be controlled by a state feed-back controller 140a, 140b as described below with respect to FIGS. 3 and 4.

The state feed-back controller 140a, 140b can control a current value 121 at the inductor L of the LC filter network 120 and a voltage value 122 at the capacitor C of the LC filter network 120.

The power converter 110 can be controlled by the state feed-back controller 140a, 140b based on a state-space model which may comprise the following variables: the current value 121 at the inductor L of the LC filter network 120, the voltage value 122 at the capacitor C of the LC filter network 120, an inductance value of the inductor L of the LC filter network 120, and a capacitance value of the capacitor C of the LC filter network 120. A control technique is described below.

The power converter 110 controlled by the state feed-back controller 140a, 140b forms with the LC filter network 120 a passive system having an output impedance 131 which phase-angle lies within a predefined range.

This passive system is configured to damp oscillations generated externally or internally by the power converter 110 and/or the LC filter network 120.

In an inverter, an output filter is needed in order to cancel the harmonics and noise that appear at high frequency, so an inductive L filter; the L filter is not very efficient when compared to a higher order output filter, such as LC and LCL and so on. In order to meet stringent harmonic standards very big inductances would be needed, so, this solution is nowadays disregarded in many applications. LC or LCL filters are usually placed but they introduce a resonance which can make the system unstable or amplify high order harmonic components. Therefore, a technique to damp this resonance is needed, ideally without losing efficiency (placing a resistance increases the losses). This damping of resonances can be performed by the state feed-back controller 140a, 140b as described in this disclosure.

In order to fully understand the control mechanism and give a value to the enhanced performance, the identification of the power converter 110 can be clarified by using the key figure of merit to assess it. The figure of merit that considers the power converter 110, filter 120 and control operation can be described by an impedance 131 or an admittance equivalent or alternatively, as a Thevenin or Norton equivalent, but the stability only depends on the Thevenin impedance or the Norton admittance. The experimental measurement of the converter impedance 131 or admittance is usually known as impedance spectroscopy.

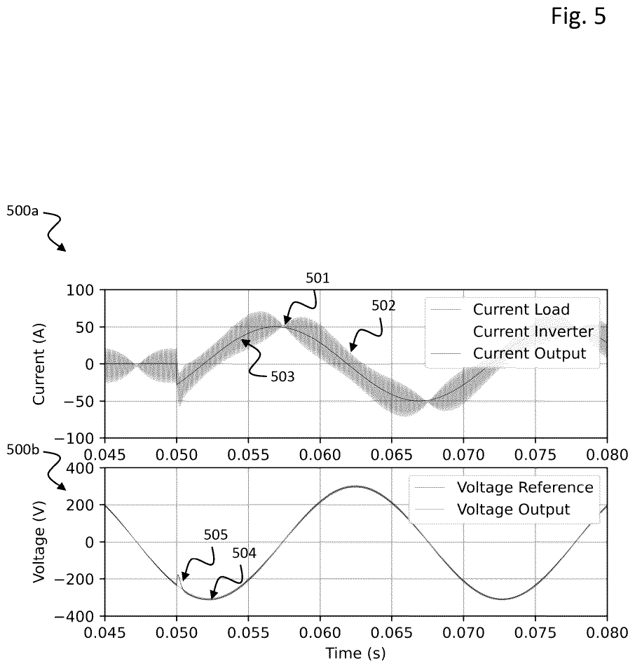

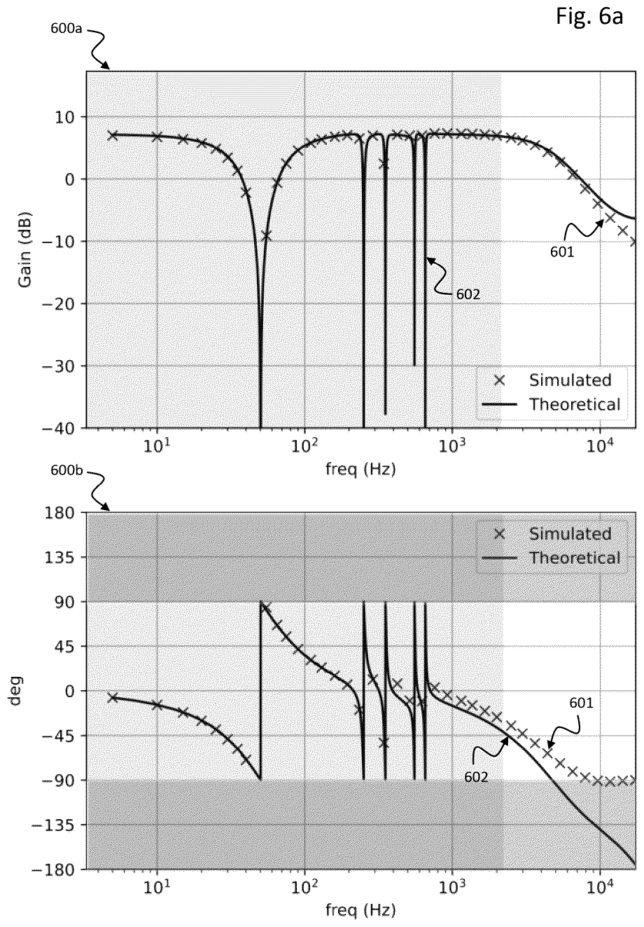

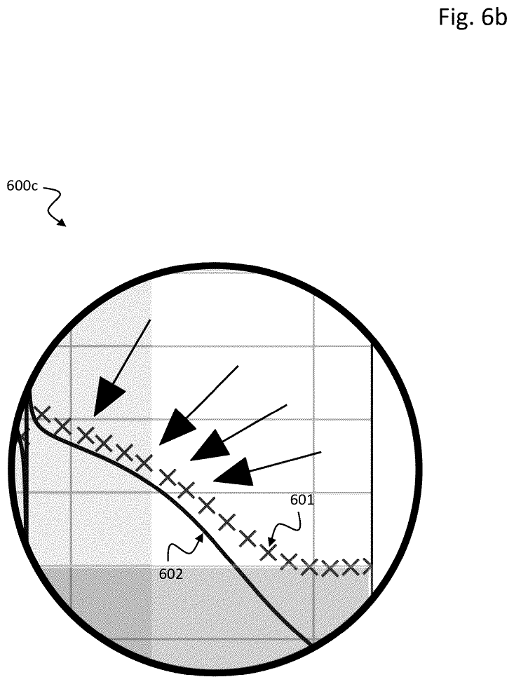

FIG. 2 shows the power converter 110 with output LC filter 120 and input current perturbation for impedance spectroscopy by frequency sweep at different frequencies to build a curve that covers main parts of the spectrum. Results are presented in the following FIGS. 5 and 6. Working in this framework, a key controller design constraint is described as shaping the impedance/admittance to fulfil the passivity criterion.

The passivity criterion refers to the mathematical fact that if the phase-angle of the impedance/admittance is between ±90 degrees, for any given frequency, it will damp the resonances at that frequency. Physical interpretation is that the system can be represented by an RLC combination of passive components, i.e., resistors, inductors and capacitors. Furthermore, passive components cannot describe a negative resistor behavior: the resistive part is always positive in the RLC equivalent. This is of a high physical insight, since a negative resistor in a Thevenin/Norton equivalent describes an electric source or sink that is prone to lead to instability.

In the following paragraphs, the variables are shown (see FIG. 2) which are used for solving the control design problem described above.
L is the filter (innermost) inductance.
C is the filter capacitor.
i_{L}(t) is the current 121 through the inductor; measurement in the time domain.
v_{C}(t) is the voltage 122 in the capacitor measurement, in the time domain.
iₒ(t) is the output current 132 measurement, in the time domain.
i_{L}(kTₛ) is the current 142 through the coil measurement, in the discrete domain.
v_{C}(kTₛ) is the voltage 141 in the capacitor measurement, in the discrete domain.
iₒ (kTₛ) is the output current 143 measurement, in the discrete domain.
Iₛ is a DC component in the dc-bus. It may represent the current coming from a PV panel or from a battery.
Iₒ is a DC current 133 at the output.
ĩₒ(t) is the perturbation 134 of the output current, in the time domain. It is used to identify the converter impedance.
\tilde{v}_{c}(ω) is the value of the capacitor voltage 151 which correspond to the ω frequency.
ĩₒ (ω) is the value of the output current 152 which correspond to the ω frequency.
Z(ω) is the value of the output impedance 131 of the system for ω frequency.

When compared to FIG. 1, the second (external) inductor is not relevant in the design problem, because the impedance of the inverter is shaped together with the LC output filter; i.e., i_{L}(t) and v_{C} (t) determine closed loop control actions. When passivity is assured for the innermost model described above, adding another external passive element, i.e., the external inductor, the passivity compliance is not impaired, unless non-optimal control actions associated to the new state are done.

In the following, a mathematical description of the implementation of the state feed-back controller 140a, 140b is given.

The inverter, i.e. power converter 110, with LC output filter 120 can be represented in state-space by the form:

$$\dot{x} ( t ) = Ax ( t ) + Bu ( t ) \qquad ( 1 )$$

$$y ( t ) = Cx ( t )$$

where x(t) are the state variables, \dot{x}(t) is the derivative of the state variables and A, B, C the state-space matrices that defined the dynamics. More specifically, with respect to the variables defined above,

$$\frac{d}{dt} ( \begin{matrix}{i}_{L} ( t ) \\ {v}_{C} ( t )\end{matrix} ) = ( \begin{matrix}0 & - \frac{1}{L} \\ \frac{1}{C} & 0\end{matrix} ) ( \begin{matrix}{i}_{L} ( t ) \\ {v}_{C} ( t )\end{matrix} ) + ( \begin{matrix}\frac{1}{L} \\ 0\end{matrix} ) {v}_{i n} ( t ) + ( \begin{matrix}0 \\ - \frac{1}{C}\end{matrix} ) {i}_{o} ( t ) \qquad ( 2 )$$

digital control is used. The next step is to send this to the discrete domain, e.g., by using a Zero Order Hold (ZOH) method, giving rise to:

$$x ( k + 1 ) = ϕ x ( k ) + {Γ}_{1} {v}_{i n} ( k ) + {Γ}_{2} {i}_{o} ( k ) \qquad ( 3 )$$

$$y ( k ) = C x ( k )$$

$$ϕ = ( \begin{matrix}cos ( \frac{{T}_{s}}{\sqrt{LC}} ) & - \sqrt{\frac{C}{L}} sin ( \frac{{T}_{s}}{\sqrt{LC}} ) \\ \sqrt{\frac{L}{C}} sin ( \frac{{T}_{s}}{\sqrt{LC}} ) & cos ( \frac{{T}_{s}}{\sqrt{LC}} )\end{matrix} )$$

$${Γ}_{1} = ( \begin{matrix}\sqrt{\frac{C}{L}} sin ( \frac{{T}_{s}}{\sqrt{LC}} ) \\ 1 - cos ( \frac{{T}_{s}}{\sqrt{LC}} )\end{matrix} )$$

$${Γ}_{2} = ( \begin{matrix}1 - cos ( \frac{{T}_{s}}{\sqrt{LC}} ) \\ \sqrt{\frac{L}{C}} sin ( \frac{{T}_{s}}{\sqrt{LC}} )\end{matrix} )$$

In this model, now, the rest of the delay due to PWM (0.5 Tₛ was added in ZOH discretization) can be introduced:

$${v}_{d} ( k + 1 ) = {v}_{i n} ( k ) \qquad ( 4 )$$

$$x ( k + 1 ) = ( \begin{matrix}ϕ & {Γ}_{1} \\ 0 & 0\end{matrix} ) x ( k ) + ( \begin{matrix}0 \\ 1\end{matrix} ) {v}_{i n} ( k ) + ( \begin{matrix}{Γ}_{2} \\ 0\end{matrix} ) {i}_{o} ( k )$$

$$x ( k + 1 ) = {ϕ}^{′} x ( k ) + {Γ}_{1}^{′} {v}_{i n} ( k ) + {Γ}_{2}^{′} {i}_{o} ( k ) \qquad ( 5 )$$

$$y ( k ) = C x ( k )$$

The control law is:

$${v}_{i n} ( k ) = - K x ( k ) \qquad ( 6 )$$

Where K=[Kᵢ Kᵥ K_{d}] are the control gains.

Substituting and going to the Z-domain, the characteristic equation of the impedance can be obtained:

$$( zI - {ϕ}^{′} + {Γ}_{1}^{′} K ) X ( z ) = {Γ}_{2}^{′} {I}_{o} ( z ) \qquad ( 7 )$$

$$y ( z ) = CX ( z )$$

$$Z ( z ) = {C ( zI - {ϕ}^{′} + {Γ}_{1}^{′} K )}^{- 1} {Γ}_{2}^{′} \qquad ( 8 )$$

The characteristic equation is:

$$\vert zI - {ϕ}^{′} + {Γ}_{1}^{′} K \vert = {z}^{3} + ( {K}_{d} - 2 a ) {z}^{2} + ( {K}_{v} + 1 - 2 {K}_{d} a - {K}_{v} a + {K}_{i} b ) z - {K}_{i} b - {K}_{v} a + {K}_{d} + {K}_{v} = 0 \qquad ( 9 )$$

$$a = cos ( \frac{{T}_{s}}{\sqrt{LC}} )$$

$$b = \sqrt{\frac{C}{L}} sin ( \frac{{T}_{s}}{\sqrt{LC}} )$$

Now, the voltage gain Kᵥ is set to 0, which means that the voltage measurement is not needed for the stability. So, the equation is:

$$\vert zI - {ϕ}^{′} + {Γ}_{1}^{′} K \vert = {z}^{3} + ( {K}_{d} - 2 a ) {z}^{2} + ( 1 - 2 {K}_{d} a - {K}_{v} a + {K}_{i} b ) z - {K}_{i} b + {K}_{d} = 0 \qquad ( 10 )$$

There are three poles and two variables, so one pole can be set with one variable and the others can be restricted with the other variable. h, m and n are unknown:

$$( {z}^{2} + hz + n ) ( z + m ) = 0 \qquad ( 11 )$$

$${z}^{3} + ( h + m ) {z}^{2} + ( hm + n ) z + mn = 0$$

By comparison:

$$h + m = {K}_{d} - 2 a \qquad ( 12 )$$

$$hm + n = 1 - 2 {K}_{d} a + {K}_{i} b$$

$$nm = - {K}_{i} b + {K}_{d}$$

Now, the conditions are imposed: m can be set and its frequency is obtained with:

$$z = - m = {e}^{- {T}_{s} ω} \qquad ( 13 )$$

And the other two poles will be equal and real:

$${h}^{2} = 4 n \qquad ( 14 )$$

Solving the system (12), with (13) and (14), the gains are obtained:

$$\frac{m + 1}{4} {K}_{d}^{2} + ( - \frac{{m}^{2}}{2} + \frac{m}{2} - am + a - 1 ) {K}_{d} + \frac{{m}^{3}}{4} - \frac{3 {m}^{2}}{4} + {am}^{2} + {a}^{2} m - am + {a}^{2} - 1 = 0 \qquad ( 15 )$$

$${K}_{i} \cdot = \frac{1}{b} [ \frac{m}{4} {K}_{d}^{2} - ( \frac{{m}^{2}}{2} + am + 1 ) {K}_{d} + \frac{{m}^{3}}{4} + {am}^{2} + {a}^{2} m ] \qquad ( 16 )$$

The design criterion presented here is to move the poles as far as possible in the frequency domain.

For that, as it was shown and described above, there are three poles, which can be divided in two groups: the pair poles and the single one. Adjusting the gains, if the single pole is faster, the other two are slower and vice-versa. Because of this, the fastest position is when all of them are in the same point:

$${( z + m )}^{3} = {z}^{3} + 3 {mz}^{2} + 3 {m}^{2} z + {m}^{3} = 0 \qquad ( 17 )$$

Using this equation and the previous idea for finding the bolded equations, the optimal frequency is obtained:

$$m = \sqrt[3]{4 a - 2 {a}^{2} - 2 + \sqrt[2]{{( 2 a - 2 )}^{3} + {( 2 {a}^{2} - 4 a + 2 )}^{2}}} - \frac{2 a - 2}{\sqrt[3]{4 a - 2 {a}^{2} - 2 + \sqrt[2]{{( 2 a - 2 )}^{3} + {( 2 {a}^{2} - 4 a + 2 )}^{2}}}} - 1 \qquad ( 18 )$$

By combining (18), (15) and (16) the innermost control action is defined by a quantifiable method that provides Ki and Kd (Kv is zero by purpose).

The next step that gives rise to two different embodiments is to develop the third point, i.e., the steady-state perfect tracking of references at 50 Hz and (relative) low order harmonics, such as 5^{th}, 7^{th}, 11^{th}, 13^{th}, etc. For that, another block which allows to follow a reference, which can be a voltage reference or a current reference, is introduced. Based on that, two different embodiments are obtained as described in the following with respect to FIGS. 3 and 4.

In these embodiments, the Selective Harmonic Steady-State Control action is done in parallel to the innermost action (state feed-back) and it is aimed to regulate to zero (steady-state) the error in inductor current (FIG. 4) or capacitor voltage (FIG. 3). The term selective points to the fact that it is only very effective around a narrow frequency band: the center of the band is the frequency of the waveform which must be followed with perfect tracking (and disturbance rejection). It does not affect the stability or passivity in the wide range, but it has to be designed to keep the passivity property in the local frequency at which the selective controller is effective. The embodiment inside the blocks 322 shown in FIGS. 3 and 4, named as “Selective Harmonic Steady-State Control” include at least one resonant controller. A resonant controller defined in the z-domain can be of the form:

$${G}_{R} ( z ) = \frac{{K}_{2} z + {K}_{1}}{{z}^{2} - 2 cos ( h {ω}_{n} {T}_{s} ) z + 1} \qquad ( 19 )$$

showing a strictly proper transfer function with two gains, K1 and K2, ωₙ is the resonant frequency, h is the order of the harmonic, and Tₛ is the controller sampling time. A proper choice of the parameters also keeps the passivity properties when the “Selective Harmonic Steady-State Control” block 322 is plugged-in the state-feed-back controller as a base-line for a controller in exemplary embodiments.

All the previous calculations were presented in the discrete domain as digital implementation is being allowed, which is the most common implementation in high power devices and, also, much more versatile.

FIG. 3 shows a circuit diagram illustrating a state feed-back controller 140a according to the present disclosure operating in a voltage mode.

The state feed-back controller 140a can be used for controlling a first physical value 121, e.g. a current 121 as described above with respect to FIG. 2, and a second physical value 122, e.g. a voltage 122 as described above with respect to FIG. 2, in a voltage mode or in a current mode.

The state feed-back controller 140a comprises a first gain stage 301 with a first gain parameter −K_{I}, e.g. as described above with respect to FIG. 2, in particular in equations (6), (10) and (16). The first gain stage 301 has an input 301a and an output 301b.

The state feed-back controller 140a comprises a second gain stage 302 with a second gain parameter −K_{V}, e.g. as described above with respect to FIG. 2, in particular in equation (6) and which can be set to zero. The second gain stage 302 has an input 302a and an output 302b.

The state feed-back controller 140a comprises a reference input 303 to receive a reference value 304.

The state feed-back controller 140a comprises a feed-back loop 322 implementing a selective harmonic steady-state control. The feed-back loop 322 has an input 322a and an output 322b. The input 322a receives a difference 321 of an input value at the input 302a of the second gain stage 302 and the reference value 304.

The state feed-back controller 140a comprises a combiner 311 for combining an output value at the output 301b of the first gain stage 301, an output value at the output 302b of the second gain stage 302 and an output value at the output 322b of the feed-back loop 322.

When the state feed-back controller is configured to be operative in the voltage mode (as shown in FIG. 3), the first physical value 121 is a current value received at the input 301a of the first gain stage 301, the second physical value 122 is a voltage value received at the input 302a of the second gain stage 302, the reference value is a reference voltage value 304 and an absolute value of the second gain parameter is smaller than an absolute value of the first gain parameter.

When the state feed-back controller is configured to be operative in the current mode (e.g. as shown in FIG. 4), the first physical value 121 is a current value received at the input 302a of the second gain stage 302, the second physical value 122 is a voltage value received at the input 301a of the first gain stage 301, and the reference value is a reference current value, and an absolute value of the first gain parameter is smaller than an absolute value of the second gain parameter.

When the state feed-back controller is configured to be operative in the current mode, the first gain parameter is set to zero or within a range around zero. As used herein, a range around zero means a value that is close to zero, e.g., 0.001, 0.01, −0.001, −0.01.

When the state feed-back controller is configured to be operative in the voltage mode, the second gain parameter is set to zero or within a range around zero.

The state feed-back controller 140a comprises a second feed-back loop 310 comprising a gain stage 303 with a third gain parameter −K_{D} and a delay stage 312 with unit delay z⁻¹. The second feed-back loop 310 is configured for feeding back an output value 310a of the combiner 311 back to the combiner 311.

The delay stage 312 delays the output value 310a of the combiner 311. The third gain parameter is applied to the delayed output value 310a of the combiner 311. An output 310b of the second feed-back loop 310 is provided to the combiner 311.

The second feed-back loop 310 may be configured according to a design criterion, e.g. as described above with respect to FIG. 2. Such a design criterion may be to move the poles of the characteristic equation according to equations (9) to (11) as far as possible in the frequency domain. A design criterion may be to set all poles of the characteristic equation at the same point in order to improve stability.

A design criterion for control systems can be one or more of the following: a) transient response (the system's response while it is changing), b) steady-state response (the system's response after it has reached steady-state), c) stability.

When the state feed-back controller is operative in the current mode, the second gain parameter and the third gain parameter can be adjusted based on the design criterion of the second feed-back loop 310.

When the state feed-back controller is operative in the voltage mode, the first gain parameter and the third gain parameter can be adjusted based on the design criterion of the second feed-back loop 310.

The power converter 110 with LC output filter 120 form a system which can be controlled by the state feed-back controller 140a. As described above with respect to FIG. 2, such system can be represented in state-space according to equation (1) shown above and modeled by a characteristic equation as described above with respect to FIG. 2. The design criterion of the second feed-back loop 310 can be based on the characteristic equation of the system controlled by the state feed-back controller 140a. Such characteristic equation can be represented by a number of zeros and a number of poles in frequency domain or z-domain.

An exemplary design criterion is to adjust the gain parameters by adjusting all poles of the characteristic equation to a same point in the frequency domain or z-domain.

The state feed-back controller 140a comprises a control output 313 for providing an output value of the combiner 311 as a control signal 144 of the state feed-back controller 140a.

When the state feed-back controller is operative in the current mode, the feed-back loop 322 can be configured to track the first physical value 121 to the reference value 404 based on a feed-back filter (not shown in FIGS. 3 and 4).

When the state feed-back controller is operative in the voltage mode, the feed-back loop 322 can be configured to track the second physical value 122 to the reference value 304 based on the feed-back filter (not shown in FIGS. 3 and 4).

The feed-back loop 322 may comprise at least one resonant controller in a time-discrete domain. The at least one resonant controller can be designed to behave as a passive system within a specified frequency range around a resonant frequency of the at least one resonant controller.

In an exemplary embodiment, multiple resonant controllers may be connected in parallel, for example.

The resonant frequency of the at least one resonant controller may correspond to a reference frequency of the reference value 304 or a harmonic of the reference frequency.

The at least one resonant controller is configured to have two poles and can be damped.

FIG. 4 shows a circuit diagram illustrating a state feed-back controller 140b according to the disclosure operating in a current mode.

The state feed-back controller 140b corresponds to the state feed-back controller 140a described above with respect to FIG. 3, but some input variables and gain parameters are different as shown in the following.

The first gain stage 301 comprises the first gain parameter −K_{V} that is set to zero in contrast to the state feed-back controller 140a of FIG. 3 where the first gain stage 301 comprises the first gain parameter −K_{I}.

The first gain stage 301 receives the second physical value 122 which is the voltage v_{C} in contrast to the state feed-back controller 140a of FIG. 3 where the first gain stage 301 receives the first physical value 121 which is the current i_{L}.

The second gain stage 302 comprises the second gain parameter −K_{I} in contrast to the state feed-back controller 140a of FIG. 3 where the second gain stage 302 comprises the second gain parameter −K_{V} that is set to zero.

The second gain stage 302 receives the first physical value 121 which is the current i_{L} in contrast to the state feed-back controller 140a of FIG. 3 where the second gain stage 302 receives the second physical value 122 which is the voltage v_{C}.

The reference input 303 receives the reference value 404 that is a reference current Iᵣ in contrast to the state feed-back controller 140a of FIG. 3 where the reference input 303 receives the reference value 304 that is a reference voltage vᵣ.

When the state feed-back controller 140b is configured to be operative in the current mode (as shown in FIG. 4), the first physical value 121 is a current value received at the input 302a of the second gain stage 302, the second physical value 122 is a voltage value received at the input 301a of the first gain stage 301, and the reference value is a reference current value, and an absolute value of the first gain parameter is smaller than an absolute value of the second gain parameter.

In particular, the first gain parameter −K_{V} can be set to zero or within a range around zero as shown in FIG. 4. A range around zero specifies small values near zero, for example caused by noise. For example, their values may be between −0.01 and 0.01 or between −0.001 and 0.001.

FIG. 5 shows time diagrams 500a, 500b of the key waveforms for current and voltage produced by the system 200 of FIG. 2.

The presented implementation, using the operation of the state feed-back controller 140a in the voltage mode, i.e. used for capacitor voltage regulation, is tested by simulation. An NPC inverter as exemplary power converter 110 with output LC filter 120 is connected to a non-linear load. A non-linear load usually refers to the fact that, asides the fundamental component, it also demands harmonic currents.

A time-domain simulation is applied to obtain the results. The simulated model corresponds to the system shown in FIG. 1 using the following simulation parameters as depicted in Table 1.

TABLE 1
Simulation parameters

| Parameter | Value | Unit |
|---|---|---|
| L | 120 10⁻⁶ | H |
| C | 30 10⁻⁶ | F |
| Ts | $\frac{1}{2 \; 18 {10}^{3}}$ | s |
| fs | $\frac{1}{{T}_{s}} = 36 {10}^{3}$ | Hz |

By the disclosed methodology, a controller implementation has been derived. First, the state-feed-back gains that achieve full range passivity gains are analyzed. By the disclosed method, all the poles are placed in the Z-domain at 8.1 kHz, which is the value obtained using equation (18) shown above with respect to FIG. 2, which gives the gains:

$$K = [ \begin{matrix}{K}_{i} & {K}_{v} & {K}_{d}\end{matrix} ] = [ \begin{matrix}4 , 8133 & 0 & 1 , 0605\end{matrix} ]$$

The zero gains imply that the capacitor voltage is not used for passivity purposes. This property is unique to the methodology presented in this disclosure. The position of all poles is:

$$z = 0 , 2430 \to f = 8100 Hz$$

However, slight changes in the gains can be applied as well without degrading the performance and stability of the power converter.

The second part of the control belongs to Selective Harmonic Steady-State Control corresponding to the block 322 as shown in FIGS. 3 and 4. For that, four harmonics and the fundamental one were chosen: the fundamental at 50 Hz, the 5^{th}, the 7^{th}, the 11^{th} and the 13^{th}. All the selective harmonic blocks (i.e., resonant filters) offer a perfect tracking of reference and total rejection of the disturbance. In a practical example, the reference is only non-zero for the main component reference; the role of selective harmonics regulation of 5^{th}, the 7^{th}, the 11^{th} and the 13^{th} is to remove the effect of any grid current disturbance at such frequencies.

The embodiment to achieve selective harmonic control with the desired performance, i.e. accurate tracking of references and rejection of the disturbances, is achieved by means of resonant filters of the exemplary form:

$${G}_{R} ( z ) = \frac{{K}_{2} z + {K}_{1}}{{z}^{2} - 2 cos ( h {ω}_{n} {T}_{s} ) z + 1} \qquad ( 20 )$$

where two gains are needed for each frequency.

So the gains (set in a row) are:

$${K}_{R} = [ {K}_{131} {K}_{132} {K}_{111} {K}_{112} {K}_{71} {K}_{72} {K}_{51} {K}_{52} {K}_{11} {K}_{12} ] = = [ \begin{matrix}- 0 , 005 & 0 , 004873 & - 0 , 005 & 0 , 004910 & - 0 , 005 \\ 0 , 004964 & - 0 , 005 & 0 , 004982 & - 0 , 02 & 0 , 019997\end{matrix} ]$$

and the harmonic orders h are 13, 11, 7, 5 and 1, i.e., two gains per component.

The load change test response is shown in FIG. 5. The first diagram 500a shows the current behavior with current load 501, current inverter 502 and current output 503. The second diagram 500b shows the voltage behavior with voltage reference 504 and voltage output 505.

At the beginning, the system is connected with no load, so the voltage reference 504 is generated and tracked, but there is not a main component of current. The switching ripple is due to PWM operation and its frequency large, far beyond controller bandwidth. At 0.05 seconds, a load is connected, so the fundamental current starts to flow from the inverter to the load. The transient response is shown in FIG. 5. The transient lines in the current and voltage are fast and well damped.

FIG. 6a shows impedance responses for gain 600a and phase 600b obtained by the system 200 of FIG. 2. FIG. 6a shows theoretical values 602 and simulated values 601 for the gain 600a and the phase 600b.

The equivalent impedance for the system can be obtained introducing a current perturbation iₒ (t) in the connection node and reading the capacitor voltage response \tilde{v}_{c}(t), as shown in FIG. 2. Next, the impedance [cf. Z(ω) in FIG. 2] is calculated from the frequency domain equivalents ĩₒ(ω) and \tilde{v}_{c}(ω). A Fourier transform can be applied to obtain frequency domain equivalents. Furthermore, following the mathematical development described above with respect to FIG. 2, a theoretical impedance can also be obtained and compared with simulation results. FIG. 6 shows the results of both impedance responses.

FIG. 6 shows that passivity is achieved.

FIG. 6b shows a zoom representation 600c of the high frequency region of the impedance response for phase 600b shown in FIG. 6a. FIG. 6b shows theoretical values 602 and simulated values 601 for the phase 600b.

The arrows show how the phase-angle starts to get smoother as the frequency increases, which makes the passivity compliance possible.

The performed simulations demonstrate the achieved passivity for the full range of frequency. The phase-angle never reaches the zone below a phase of −90° that limits the boundaries of passivity compliance. It can be seen how pessimistic the Z-domain in the very high frequency range of spectrum. The design rule of placing the closed-loop eigenvalues at a higher frequency as possible is well supported by the empirical tests.

The control method described in this disclosure can be applied to every single inverter followed by a LC or LCL filter. The present disclosure mostly describes embodiments associated with PV inverters and in UPS systems, where stability is a key point. However, the AC voltage sensor can be removed without degrading stability because it is dependent only on the converter current sensor.

Exemplary embodiments included the present disclosure include other options usch as:
Option 1) If the inverter is working in current control mode, the AC voltage sensor is not needed. This is cost-effective, material saving, useful in sensorless applications, combining possibility with indirect synchronization schemes.
Option 2) Working in an AC voltage control mode (which implies 50/60 Hz waveform component and some low order harmonics) a bandlimited AC voltage sensing is needed. This results in a robust, cost-effective solution that does not include aliasing problems.

Moreover, topologies based on high bandgap devices (fast sampling/switching), like the next generation transistor of SiC or GaN will require devices and control techniques with a higher bandwidth. Furthermore, limiting the requirements for AC voltage sensor will make things easier and cost-effective.

As is described herein the performance waveforms achieve very fast transient responses.

The techniques described in this disclosure can also be applied to a method for controlling converters compressing an output LC filter (LC as a minimum order for high order output filters with more components, such as LCL), which is determined by the following unique features: it fulfils the passivity criterion in all range of the spectrum and, moreover, the high-frequency region spectrum is not dependent on the ac-voltage sensor, but only on the inverter current sensing. So the passivity fulfilment is independent on the existence or value of the capacitor ac-voltage waveform, and the implementation examples described above contain selective voltage/current controllers that provide zero steady-state error for low frequency components (e.g., 50 Hz and low order harmonics).

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as specifically described herein.

What is claimed is:

1. A state feed-back controller for controlling a first physical value and a second physical value in a voltage mode or in a current mode, the state feed-back controller comprising:
a first gain stage with a first gain parameter, the first gain stage having an input and an output;
a second gain stage with a second gain parameter, the second gain stage having an input and an output;
a reference input to receive a reference value;
a feed-back loop having an input and an output, the input of the feed-back loop receiving a difference of an input value at the input of the second gain stage and the reference value; and
a combiner for combining an output value at the output of the first gain stage, an output value at the output of the second gain stage and an output value at the output of the feed-back loop,
wherein, when the state feed-back controller is configured to be operative in the current mode, the first physical value is a current value received at the input of the second gain stage, the second physical value is a voltage value received at the input of the first gain stage, and the reference value is a reference current value, and wherein an absolute value of the first gain parameter is smaller than an absolute value of the second gain parameter; or
wherein, when the state feed-back controller is configured to be operative in the voltage mode, the first physical value is a current value received at the input of the first gain stage, the second physical value is a voltage value received at the input of the second gain stage, the reference value is a reference voltage value and wherein an absolute value of the second gain parameter is smaller than an absolute value of the first gain parameter.

2. The state feed-back controller of claim 1,
wherein, when the state feed-back controller is configured to be operative in the current mode, the first gain parameter is set to zero or within a range around zero; or
wherein, when the state feed-back controller is configured to be operative in the voltage mode, the second gain parameter is set to zero or within a range around zero.

3. The state feed-back controller of claim 1, further comprising:
a second feed-back loop configured to feed back an output value of the combiner to the combiner,
the second feed-back loop comprising a delay stage for delaying the output value of the combiner and a third gain stage with a third gain parameter for applying the third gain parameter to the delayed output value of the combiner.

4. The state feed-back controller of claim 2, further comprising:
a second feed-back loop configured to feed back an output value of the combiner to the combiner,
the second feed-back loop comprising a delay stage for delaying the output value of the combiner and a third gain stage with a third gain parameter for applying the third gain parameter to the delayed output value of the combiner.

5. The state feed-back controller of claim 3,
wherein the second feed-back loop is configured according to a design criterion, wherein, when the state feed-back controller is operative in the current mode, the second gain parameter and the third gain parameter are adjusted based on the design criterion of the second feed-back loop; or
wherein, when the state feed-back controller is operative in the voltage mode, the first gain parameter and the third gain parameter are adjusted based on the design criterion of the second feed-back loop.

6. The state feed-back controller of claim 4,
wherein the second feed-back loop is configured according to a design criterion, wherein, when the state feed-back controller is operative in the current mode, the second gain parameter and the third gain parameter are adjusted based on the design criterion of the second feed-back loop; or
wherein, when the state feed-back controller is operative in the voltage mode, the first gain parameter and the third gain parameter are adjusted based on the design criterion of the second feed-back loop.

7. The state feed-back controller of claim 1, further comprising:
a control output for providing an output value of the combiner as a control signal of the state feed-back controller.

8. The state feed-back controller of claim 2, further comprising:
a control output for providing an output value of the combiner as a control signal of the state feed-back controller.

9. The state feed-back controller of claim 1,
wherein, when the state feed-back controller is operative in the current mode, the feed-back loop is configured to track the first physical value to the reference value based on a feed-back filter or
wherein, when the state feed-back controller is operative in the voltage mode, the feed-back loop is configured to track the second physical value to the reference value based on the feed-back filter.

10. The state feed-back controller of claim 2,
wherein, when the state feed-back controller is operative in the current mode, the feed-back loop is configured to track the first physical value to the reference value based on a feed-back filter or
wherein, when the state feed-back controller is operative in the voltage mode, the feed-back loop is configured to track the second physical value to the reference value based on the feed-back filter.

11. The state feed-back controller of claim 9,
wherein the feed-back loop comprises a resonant controller in a time-discrete domain, wherein the resonant controller is a passive system within a specified frequency range around a resonant frequency of the resonant controller.

12. The state feed-back controller of claim 11,
wherein the resonant frequency of the resonant controller corresponds to a reference frequency or a harmonic of the reference frequency.

13. The state feed-back controller of claim 11,
wherein the resonant controller is configured to have two poles for a damping.

14. The state feed-back controller of claim 12,
wherein the resonant controller is configured to have two poles for a damping.

15. A power converter comprising:
an input for receiving a direct current, DC, voltage; and
at least one output for providing an alternating current, AC, voltage at a reference frequency, wherein the at least one output is connected to an LC filter network, the LC filter network comprising an inductor (L) and a capacitor (C),
wherein the power converter is controlled by a state feed-back controller;
the state feed-back controller for controlling a first physical value and a second physical value in a voltage mode or in a current mode, the state feed-back controller comprising:
a first gain stage with a first gain parameter, the first gain stage having an input and an output;
a second gain stage with a second gain parameter, the second gain stage having an input and an output;
a reference input to receive a reference value;
a feed-back loop having an input and an output, the input of the feed-back loop receiving a difference of an input value at the input of the second gain stage and the reference value;
a combiner for combining an output value at the output of the first gain stage, an output value at the output of the second gain stage and an output value at the output of the feed-back loop,
wherein, when the state feed-back controller is configured to be operative in the current mode, the first physical value is a current value received at the input of the second gain stage, the second physical value is a voltage value received at the input of the first gain stage, and the reference value is a reference current value, and wherein an absolute value of the first gain parameter is smaller than an absolute value of the second gain parameter; or
wherein, when the state feed-back controller is configured to be operative in the voltage mode, the first physical value is a current value received at the input of the first gain stage, the second physical value is a voltage value received at the input of the second gain stage, the reference value is a reference voltage value and wherein an absolute value of the second gain parameter is smaller than an absolute value of the first gain parameter.

16. The power converter of claim 15,
wherein the first physical value is a current value at the inductor (L) of the LC filter network and the second physical value is a voltage value at the capacitor (C) of the LC filter network.

17. The power converter of claim 16,
wherein the power converter is controlled by the state feed-back controller based on a state-space model, the state space model comprising:
the current value at the inductor (L) of the LC filter network,
the voltage value at the capacitor (C) of the LC filter network,
an inductance value of the inductor (L) of the LC filter network, and
a capacitance value of the capacitor (C) of the LC filter network.

18. The power converter of claim 15,
wherein the power converter controlled by the state feed-back controller forms with the LC filter network a passive system having an output impedance which phase-angle lies within a predefined range.

19. The power converter of claim 16,
wherein the power converter controlled by the state feed-back controller forms with the LC filter network a passive system having an output impedance which phase-angle lies within a predefined range.

20. The power converter of claim 18,
wherein the passive system is configured to damp oscillations generated externally or internally by the power converter and/or the LC filter network.
